(19) United States
(12) Patent Application Publication
(10) Pub. No.: US 2025/0274443 A1
(43) Pub. Date: Aug. 28, 2025

(54) METHOD AND SYSTEM FOR SECURE COMMUNICATION

(71) Applicant: SAMSUNG ELECTRONICS CO., LTD., Suwon-si (KR)

(72) Inventor: Ritesh SINGH, Noida (IN)

(73) Assignee: SAMSUNG ELECTRONICS CO., LTD., Suwon-si (KR)

(21) Appl. No.: 19/209,394

(22) Filed: May 15, 2025

Related U.S. Application Data
(63) Continuation of application No. PCT/KR2023/006671, filed on May 17, 2023.

(30) Foreign Application Priority Data
Nov. 16, 2022 (IN) 202211065689

(51) Int. Cl. H04L 9/40; G06T 7/00; G06T 7/90; H04L 9/08; H04N 25/618

(52) U.S. Cl. CPC H04L 63/0428; G06T 7/0002; G06T 7/90; H04L 9/0869; H04N 25/618; G06T 2207/10024; G06T 2207/30168

(57) ABSTRACT

A method for secure communication, may include: capturing at least one dark image including a dark noise region; extracting at least one noisy pixel from the at least one dark image in a plurality of color spaces; determining, a color space, among the plurality of color spaces, including a minimum number of the at least one noisy pixel, based on the at least one noisy pixel; selecting, from the color space, a set of the at least one noisy pixel having a lowest pixel value; generating an unbiased bitstream based on a biased bitstream corresponding to the set of the at least one noisy pixel using a randomness extraction method; and generating a random cryptographic key based on the unbiased bitstream.

### CROSS-REFERENCE TO RELATED APPLICATIONS

This application is a continuation application of International Application No. PCT/KR2023/006671, filed on May 17, 2023, which is based on and claims priority to Indian patent application Ser. No. 20/221,1065689, filed on Nov. 16, 2022, in the Indian Patent Office, the disclosures of which are incorporated by reference herein in their entireties.

### BACKGROUND

### 1. Field

The present disclosure generally relates to a method and system for secure communication, and more particularly, to a method and system for generating a random cryptographic key utilizing on-device hardware for facilitating secure communication.

### 2. Description of Related Art

With the ever-increasing demand for digital transactions, the improvisation of security in digital transactions acquires the utmost importance in recent years. A cryptography method provides security by transforming plain text data into cipher text data, such that only the recipient of the data can view the content. The cryptography method requires a key for converting the plain text into the cipher text and vice versa. However, the key length is turning out to be inadequately long for getting protection against intruders having a high-speed computing system. Otherwise, the intruder with the high-speed system may easily predict the key to decipher the encrypted text. In addition, the increasing length of the key may only remain strong if randomness is ensured for generating the key. In most of the existing systems, the randomness of generating the key is not ensured since the keys are generated using a pseudo-random key generator. The intruder can easily predict the key generated using the pseudo-random generator, as the generator uses a mathematical procedure for generating a sequence of random numbers. Therefore, with the knowledge of the mathematical procedure and state of the system, the intruder can easily predict the key to decrypt the cipher text to retrieve information.

The randomness of the generator is the most essential component for accomplishing secure communication by generating the random key, which cannot be predicted by the intruder or attacker. Therefore, the truly random key is highly desirable to make the system more secure. However, very few natural processes generate a truly random number for generating the truly random key. The processes, for example, a quantum tunneling process, a radio-active decay process, etc. provide truly random numbers based on the randomness of the intrinsic process that cannot be predicted in advance under any circumstances. These types of processes of generating truly random numbers are known as a quantum effect/process.

Further, existing ways of generating truly random numbers require costly external hardware to create and measure a random physical process. Also, lower-cost hardware such as an avalanche diode, is used for generating random numbers. However, such hardware is not efficient for generating a provably random number, that is, the truly random number. In general, the provably random number is generated by the quantum effect/process. On contrary, a non-quantum effect/process is unable to generate truly random numbers due to some specific limitations. For example, the non-quantum method involves a repetitive process to generate random numbers. Such repetitive processes may be predicted with the knowledge of internal algorithms and a state of the system. As a non-liming example, a quantum key generator Universal Serial Bus (USB) may cost $1,000 for generating the truly random number utilizing the Complementary Metal-Oxide-Semiconductor (CMOS) quantum effect.

Thus, it is recommended not to use the traditional key generation method for high-security communication areas such as defense communication, corporate bonds transaction, and communication between top-level government officials. Particularly, the traditional key generation method utilizes the pseudo-random number generator to generate truly random numbers. Further, the lack of sufficient variability in VoLTE encryption keys is a known vulnerability in which ReVoLTE attack generally occurs. In addition, many IoT (Internet of Things) systems use insecure keys leading to remote control attacks, such as Verkada breach, BotenaGo attack, My Book Live attack, Mirai attack, and Rolljam attack, which occurred due to insecure keys in IoT devices.

Therefore, in order to solve the above-mentioned problems, there lies a need for a method and system that can generate the truly random number to get the random cryptographic key without utilizing any additional costly hardware.

### SUMMARY

This summary is provided to introduce a selection of concepts, in a simplified format, that are further described in the detailed description of the disclosure. This summary is neither intended to identify key or essential concepts of the disclosure nor is it intended for determining the scope of the disclosure.

According to an aspect of the disclosure, a method for secure communication, includes: capturing at least one dark image including a dark noise region; extracting at least one noisy pixel from the at least one dark image in a plurality of color spaces; determining a color space, among the plurality of color spaces, including a minimum number of the at least one noisy pixel, based on the at least one noisy pixel; selecting, from the color space, a set of the at least one noisy pixel having a lowest pixel value; generating an unbiased bitstream based on a biased bitstream corresponding to the set of the at least one noisy pixel using a randomness extraction method; and generating a random cryptographic key based on the unbiased bitstream.

According to an aspect of the disclosure, a device for secure communication, includes: an image sensor configured to capture at least one dark image including a dark noise region; memory storing at least one instruction; and at least one processor operatively coupled with the image sensor and the memory, wherein the at least one instruction, when executed by the at least one processor individually or collectively, causes the device to: extract at least one noisy pixel from the at least one dark image in a plurality of color spaces; determine, a color space including a minimum number of the at least one noisy pixel, based on the at least one noisy pixel; select, from the color space, a set of the at least one noisy pixel having a lowest pixel value; generate, using a randomness extraction method, an unbiased bitstream based on a biased bitstream corresponding to the set of the at least one noisy pixel; and generate a random cryptographic key based on the unbiased bitstream.

According to an aspect of the disclosure, a non-transitory machine-readable medium contains instructions that, when executed, cause at least one processor of a device to perform a method for secure communication, including capturing at least one dark image including a dark noise region; extracting at least one noisy pixel from the at least one dark image in a plurality of color spaces; determining a color space, among the plurality of color spaces, including a minimum number of the at least one noisy pixel, based on the at least one noisy pixel; selecting, from the color space, a set of the at least one noisy pixel having a lowest pixel value; generating an unbiased bitstream based on a biased bitstream corresponding to the set of the at least one noisy pixel using a randomness extraction method; and generating a random cryptographic key based on the unbiased bitstream.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates an example block diagram of a system for secure communication, in accordance with an embodiment of the present disclosure;

FIG. 1B illustrates an example block diagram of a device for secure communication, in accordance with an embodiment of the present disclosure;

FIG. 2 illustrates an example block diagram of a system for secure communication, in accordance with an embodiment of the present disclosure;

FIG. 3 illustrates a flowchart of a method of secure communication, in accordance with an embodiment of the present disclosure;

FIG. 4 illustrates a flowchart of subsequent operations of operation 307 as disclosed in FIG. 3, in accordance with an embodiment of the present disclosure;

FIG. 5 illustrates an example use case of determining an unbiased bit stream from a dark noise input, in accordance with an embodiment of the present disclosure;

FIG. 6A illustrates a column chart disclosing a percentage of zero-value pixels in each color space, in accordance with an example embodiment of the present disclosure;

FIG. 6B illustrates a percentage of noisy pixel values in one or more dark images, in accordance with an example embodiment of the present disclosure;

FIG. 6C illustrates a Fano factor value with respect to a pixel value, in accordance with an example embodiment of the present disclosure; and

FIG. 7 illustrates an example implementation of a typical hardware configuration of the system for secure communication, in accordance with an embodiment of the present disclosure.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Further, elements in the drawings are illustrated for simplicity and may not have necessarily been drawn to scale. For example, the flowcharts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments”. The term “in an example embodiment” refers to an example with respect to the embodiment of the present disclosure.

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

As used herein, expressions such as “at least one of,” when preceding a list of elements, modify the entire list of elements and do not modify the individual elements of the list. For example, the expression, “at least one of a, b, or c,” should be understood as including only a, only b, only c, both a and b, both a and c, both b and c, or all of a, b, and c.

Unless otherwise defined, all terms, and especially any technical and/or scientific terms, used herein may be taken to have the same meaning as commonly understood by one having ordinary skill in the art.

Embodiments of the present disclosure will be described below in detail with reference to the accompanying drawings.

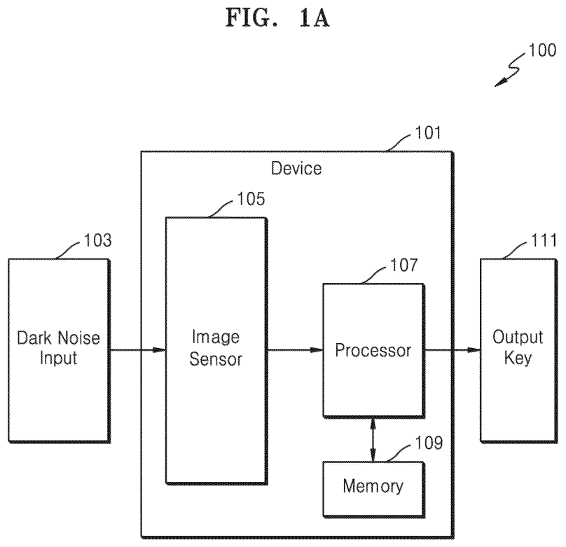

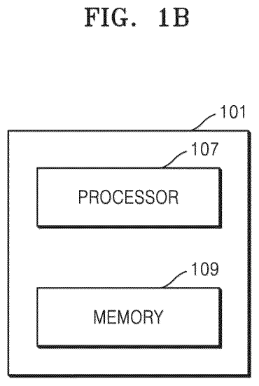

FIG. 1A illustrates an example block diagram of a system for secure communication, in accordance with an embodiment of the present disclosure. The system 100 includes a device 101 configured to receive a dark noise input 103 and generate an output key 111. The device 101 includes one or more image sensors 105, a one or more processors 107, and a memory 109. As an example embodiment, the device may correspond but is not limited to, a computing device or handheld or portable electronic device capable of transmitting beacon signal such as a mobile phone, a laptop, a paging device, a personal digital assistant, a computer, a smartphone, a tablet, and other mobile devices.

The dark noise input 103 is an input to the one or more image sensors 105 without having any light source. The one or more image sensors 105 captures a dark image corresponding to the dark noise input 103. In general, if any light ray from a light source falls on an object, the light rays get reflected from the object. Further, the reflected light rays are received by the image sensor or camera to capture the object. On contrary, in absence of any light source, the one or more image sensors 105 captures the dark image without having any object details due to the non-reflection of the light rays on the object. Further, the dark image includes a dark noise region in its entirety, wherein the dark noise region is presented by a zero-value pixel.

The one or more image sensors 105 is configured to receive light and color spectrums and convert these color spectrums into electrical energy. Further, the electrical energy is converted into the digital signals for being represented by zeros and ones. The device 101 includes at least one camera or one or more image sensors 105 for capturing an image. Further, the one or more image sensors 105 includes CMOS (Complementary Metal Oxide Semiconductor) transistors for receiving the light and color spectrums. The CMOS transistors include one or more electrons, which get energized by the received light and color spectrums for capturing the object.

In an embodiment, the one or more image sensors 105 is configured to receive the dark noise input 103 as the input. Therefore, all pixel values of the digital image data corresponding to the received dark noise input 103 are of zero value. However, due to an intrinsic property of the CMOS transistors, the digital image data of the dark noise includes one or more noisy pixels, in which the pixel value of the one or more noisy pixels is a positive integer value. The one or more noisy pixels may be included in the digital image data of the dark noise for at least one of three reasons: a heat noise effect, a hardware bias property, or a quantum tunneling process. In the heat noise effect, one or more electrons may escape from the CMOS transistor due to an increase in temperature of the one or more image sensors 105 while being used for capturing the images or any other reasons. Further, in the hardware bias properties, one or more electrons may escape from the CMOS transistors due to their hardware and manufacturing properties. Furthermore, in the quantum tunneling process, the electrons of the CMOS transistors may tunnel through a potential barrier or well randomly due to quantum effects. The quantum tunneling or tunneling is a quantum mechanical phenomenon in which a potential energy energizes the electrons to overcome the barrier or well in a truly random nature. The truly random nature of the quantum tunneling is mathematically proven by Schrodinger's equation. The present disclosure utilizes the truly random nature of the quantum tunneling phenomenon in the CMOS transistor/sensor of the inbuilt camera or image sensor 105 of the device 101 for generating the truly random number to produce a cryptographic key.

The processor 107 of the device 101 is a central processing unit (CPU). As an example embodiment, the processor 107 may be one or more general processors, digital signal processors, application-specific integrated circuits, field-programmable gate arrays, servers, networks, digital circuits, analog circuits, combinations thereof, or other now-known or later-developed devices for analyzing and processing data. The processor 107 may implement a software program, such as code generated manually (i.e., programmed). In an embodiment, the processor 107 of the device 101 receives the one or more dark images captured by the one or more image sensors 105. The processor 107 further extracts one or more noisy pixels in each color space of the one or more color-spaces from the one or more dark images. The noisy pixels may be generated by any of the three reasons: the heat noise effect, the hardware bias property, or the quantum tunneling process. In a non-limiting example, the color spaces may be Red, Green, and Blue (RGB). Subsequently, the processor 107 determines the color space that corresponds to least number of the one or more noisy pixels. Furthermore, in the determined color space, the processor 107 selects a set of noisy pixels having a lowest pixel value among pixel values of the one or more noisy pixels. The lowest pixel value may relate to the noise generated by the quantum tunneling effect, which is truly random in nature. The one or more dark images are represented by a bitstream, which is a binary sequence of bits. A biased bitstream is extracted from the bitstream having the selected set of noisy pixels. The biased bitstream corresponds to a bitstream in which a fraction value of a total number of the one or more noisy pixels with respect to a total number of the plurality of noiseless pixels tends towards zero. In other words, most of the biased bitstream is zero-value pixels, i.e., the noiseless pixels, and the least of the biased bitstream relates to noisy pixels having pixel value. Further, the processor utilizes at least one randomness extraction method from a plurality of randomness extraction methods for generating an unbiased bitstream from the biased bitstream. The unbiased bitstream corresponds to a bitstream in which a fraction value of the total number of one or more noisy pixels with respect to the total number of the plurality of noiseless pixels tends towards one. In other words, the number of zero-value pixels, i.e., the noiseless pixels, and the number of non-zero positive-value pixels, i.e., the noisy pixels, in the unbiased bitstream are close to equal. Upon generating the unbiased bitstream, the processor generates the random cryptographic key based on the generated unbiased bitstream.

The memory 109 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 109 is communicatively coupled with the processor 107 to store bitstreams or processing instructions for completing the process.

The output key 111 module receives the generated random cryptographic key from the processor 107 for facilitating the cryptographic process. The output key 111 may be utilized to encrypt any plain text to generate a cipher text for transmitting from a transmitter device to a receiver device via any communication medium. Further, the output key 111 may be utilized to decrypt the cipher text into the plain text on the receiver device to read or understand the message or content of the plain text.

FIG. 1B illustrates an example block diagram of a device for secure communication, in accordance with an embodiment of the present disclosure. The device 101 includes at least one processor 107, and one or more memories 109. As an example embodiment, the device 101 may correspond but is not limited to a computing device or handled or portable electronic device such as a mobile phone, a laptop, a paging device, a personal digital assistant, a computer, a smartphone, a tablet, and other mobile devices.

The processor 107 may include one or a plurality of processors. At this time, on or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 107 may be implemented as one or more microprocessors, microcomputers, microcontrollers, digital signal processors, central processing units, state machines, logic circuitries, and/or any devices that manipulate signals based on operational instructions.

As an example embodiment, the processor 107 may be one or more general processors, digital signal processors, application-specific integrated circuits, field-programmable gate arrays, servers, networks, digital circuits, analog circuits, combinations thereof, or other now-known or later-developed devices for analyzing and processing data. The processor 107 may implement a software program, such as code generated manually (i.e., programmed). In an embodiment, the processor 107 of the device 101 receives the one or more dark images captured by the one or more image sensors. The processor 107 further extracts one or more noisy pixels in each color space of the one or more color-spaces from the one or more dark images. Subsequently, the processor 107 determines the color space that corresponds to least number of the one or more noisy pixels. Furthermore, in the determined color space, the processor 107 selects a set of noisy pixels having a lowest pixel value among pixel values of the one or more noisy pixels. Further, the processor 107 utilizes at least one randomness extraction method from a plurality of randomness extraction methods for generating an unbiased bitstream from the biased bitstream. Upon generating the unbiased bitstream, the processor 107 generates the random cryptographic key based on the generated unbiased bitstream.

The memory 109 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 109 is communicatively coupled with the processor 107 to store bitstreams or processing instructions for completing the process.

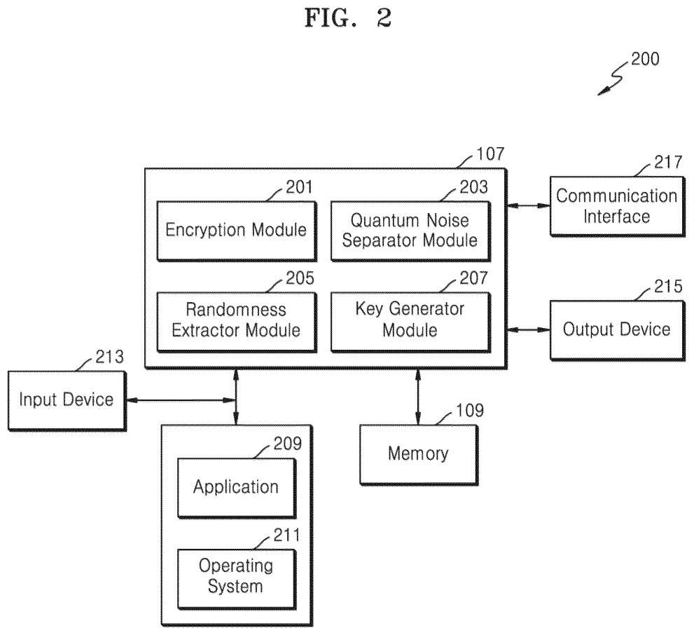

FIG. 2 illustrates an example block diagram of a system for performing secure communication, in accordance with an embodiment of the present disclosure.

The system 200 includes the processor 107, an application 209, an operating system 211, and the memory 109. The system 200 further includes an input device 213, a communication interface 217, and an output device 215.

In addition, the system includes one or more modules including an encryption module 201, a quantum noise separator module 203, a randomness extractor module 205, and a key generator module 207. The term “modules” used herein may imply a unit including, for example, one of hardware, software, and firmware or a combination of two or more of them. The “modules” may be interchangeably used with a term such as logic, a logical block, a component, and the like. The “module” may be a minimum system component for performing one or more functions or may be a part thereof. The processor 107 may control these modules to execute a specific set of operations described herein.

In an embodiment, the application 209 corresponds to an app or any kind of application software designed to provide a user interface and processing environment for fulfilling user requirements. The application 209 frequently receives input from users for providing necessary details as per the users' requirements. As a non-liming example, the application 209 is configured to run on any operating system such as windows, Linux, android, iOS, and the like. Further, the application 209 may require much stricter development criteria and quality assurance processes for being released in the application's central storage system.

In an embodiment, the application 209 is configured to receive a plain text from a user for encryption. Upon receiving the plain text from the user, the application 209 is configured to transmit the plain text to the encryption module 201.

In an embodiment, the encryption module 201 receives the plain text from the application 209 for encrypting the plain text into a cipher text. The encryption module 201 requires a cryptographic key for encrypting the plain text. To receive the cryptographic key, the encryption module 201 transmits a key specification to the operating system (OS) 211. The key specification is based on the user requirements associated with at least one of a time taken by the processor 107 to generate the cryptographic key or a complexity level of the generated cryptographic key. Further, once the encryption module 201 receives the cryptographic key from the OS 211, the encryption module 201 encrypts the plain text to the cipher text and transmits the generated cipher text to the application 209.

The OS 211 is an interface between the user and hardware of the device 101. The OS 211 is configured to initialize all hardware components of the device after being initially loaded by a bootstrap program at the time of switching on the device 101. Further, the OS 211 may also configure to perform all basic tasks of the device, such as process management, memory management, handling input/output, access to the user applications, and managing plurality of contexts or system contexts, etc.

In an example embodiment, the OS may correspond but is not limited to, an operating system such as windows, Linux, android, iOS, and the like. In an embodiment, the OS 211 is configured to receive the key specification from the encryption module 201 based on user requirements. Consequently, the OS 211 transmits the received key specification to the quantum noise separator module 203.

In an embodiment, the quantum noise separator module 203 receives the dark noise input 103 without any light source from the input device 213. In an embodiment, the input device 213 may be the one or more image sensors 105 for receiving the dark noise input 103, i.e., the dark image. The input device 213 is configured to capture, using the one or more image sensors 105, the dark image and transmit it to the quantum noise separator module 203 for further processing.

For capturing the dark noise input 103, the smallest ISO value for the one or more image sensors 105 is set, so that no artificial attenuation is captured by the image sensor. Further, the smallest shutter speed is also set for the input device 213.

For a non-limiting example, the ISO value is set as 400 for the image sensor and the shutter speed is set as 1/12000 for a mobile device model-Samsung S21. In addition, an aperture of the one or more image sensors 105 should be covered properly either manually or using robotic hardware in order to capture the dark image considered as the dark noise input 103. Subsequently, the input device 213 transmits the dark image to the quantum noise separator module 203.

The dark image includes a dark noise region in its entirety, wherein the dark noise includes the one or more noisy pixels and a plurality of noiseless pixels. Further, the one or more noisy pixels correspond to pixels that are generated as a result of one of a quantum effect or a non-quantum effect while capturing the one or more dark images. The quantum noise separator module 203 is configured to separate the one or more noisy pixels generated by the quantum effect.

The quantum noise separator module 203, upon receiving the dark image from the input device 213, extracts one or more noisy pixels from the dark images in each color space from a plurality of color spaces. Further, the quantum noise separator module 203 determines a color space, among the plurality of color spaces, that corresponds to least number of the one or more noisy pixels. Furthermore, the quantum noise separator module 203 selects a set of noisy pixels having a lowest pixel value among pixel values of the one or more noisy pixels.

For selecting the set of noisy pixels having the lowest pixel value, the quantum noise separator module 203 calculates a Fano factor value corresponding pixel value of each of the one or more noisy pixels. The Fano factor value is a ratio of variance of the pixel values of the one or more noisy pixels and the plurality of noiseless pixels to a mean of the pixel value. Fano factor is a quantifier of randomness, with a process being increasingly random the closer its Fano factor value is to one.

Further, the quantum noise separator module 203 determines the pixel value of each of the one or more noisy pixels having the Fano factor value tends to one. The pixel value corresponding to the Fano factor tends to one indicates that such pixel value is generated as a result of the quantum effect, i.e., noise generated by the quantum tunneling. The quantum tunneling occurs when one or more electrons in the quantum well randomly tunnel through a potential barrier due to random energization, and thereby the one or more electrons generate quantum noise in the dark image.

Also, the probability of tunneling decreases exponentially with an increase in the number of tunneled electrons. In addition, the quantum noise separator module 203 discards the rest of the noisy pixels having more pixel values since there is a higher chance of contamination due to non-quantum noise in the rest of the noisy pixels having more pixel values. Further, the quantum noise separator module 203 separates the smallest detected noise level to ensure that the noise is generated due to the quantum tunneling only.

The quantum noise separator module 203 selects a biased bitstream from the selected set of noisy pixels. Therefore, the biased bitstream includes the noisy pixels generated by the quantum effect, i.e., by the quantum tunneling, and the noiseless pixels. Further, the quantum noise separator module 203 thereby transmits the biased bitstream to the randomness extractor module 205.

In a non-limiting example, the image sensor captures the dark image of 1K*1K pixels, in which only 1 lowest value pixel has the Fano factor tending to one. Thus, the quantum noise separator module 203 extracts the lowest value pixel and thereby selects the biased bitstream of 100*100 pixels in which only one pixel has the pixel value (noisy pixel), and all other pixels have the pixel value 0 (non-noisy pixels). Further, all remaining pixels of the dark image are disregarded.

In an embodiment, the randomness extractor module 205 receives the biased bitstream from the quantum noise separator module 203. The bitstream is heavily biased because of the low noise levels in the CMOS sensor. Therefore, the randomness extractor module 205 generates an unbiased bitstream from the biased bitstream utilizing a randomness extraction method among a plurality of randomness extraction methods. The quantum noise generated by the CMOS sensor includes a very low level of noisy pixels and a maximum of noiseless pixels. However, the cryptography key generator module 207 requires the input bitstream with equal probability of the noisy pixels and the noiseless pixels, that is, the unbiased bitstream. Thus, the randomness extractor module 205 generates the unbiased bitstream from the biased bitstream.

The plurality of randomness extraction methods comprises at least one of a Vonrand method, an Avgrand method, a Lhlrand method, a Minrand method, or a Sinrand method. The Vonrand method includes a Von Neumann randomness extraction process for generating the unbiased bitstream from the biased bitstream. Further, the Avgrand method includes a SHA (Secure Hash Algorithm) and a Shannon Entropy-based randomness extraction process for generating the unbiased bitstream. Similarly, the Lhlrand method includes the SHA and a Leftover Hash Lemma based randomness extraction process for randomly generating the unbiased bitstream. Further, the Minrand method includes the SHA and a Minimum Entropy based randomness extraction process for providing randomness in generating the unbiased bit stream. Moreover, the Sinrand method includes a Chaotic Sine based randomness extraction process for generating the unbiased bitstream.

The Vonrand method utilizes the Von Neumann randomness extraction method for generating the random unbiased bitstream from the biased bitstream received from the quantum noise separator module 203. In the Von Neumann randomness extraction method, if each bit of the biased bitstream is independent, that is, if the probability of each next bit of the biased distribution of the bit in the bitstream does not dependent on the historical sequence, then we can extract uniformly random bits with the method. In other words, the Von Neumann randomness extraction method includes a series of following operations mentioned below:
Operation 1: Check the next two bits from the biased bitstream input sequence;
Operation 2: If the next two bits are similar, then continue; or
Operation 3: Else, output a first bit of the two bits.

Thus, as a result, the input bits are discarded if the two bits are similar. Therefore, the biasness of the input biased bitstream is eliminated to generate the unbiased bitstream. Further, since the first pair of the input biased bitstream are discarded for being similar and the second pair generates one bit for being dissimilar, therein four bits of input bitstream are expected to provide one bit of output random bitstream.

The Avgrand method utilizes the SHA and the Shannon Entropy based randomness extraction process for generating the random unbiased bitstream from the input biased bitstream. The Shannon Entropy based randomness extraction method is utilized for determining an entropy per bit of the bitstream. The entropy relates to the information available in each bit. Particularly, the entropy relates to a measurable physical property, which is most commonly associated with a state of disorder, randomness, or uncertainty. The Avgrand method performs the following operations:
Operation 1: Determine the entropy per bit, S_{avg}, for each bit of the input biased bitstream;
Operation 2: Determine X by taking a ceiling value of Y divided by S_{avg}, wherein Y is the number of output bits required from the SHA process, X is a variable integer;
Operation 3: Extract a bitstream of X bits from the input biased bitstream; and
Operation 4: Calculate the SHA hash of the X bits bitstream to generate Y bit unbiased hash bitstream, which is random in nature.

For example, the calculation of determining the entropy per bit S_{avg} is given in equation (1).

$${s}_{avg} = {\sum }_{i} - {p}_{i} log {p}_{i} = - {p}_{0} log {p}_{0} - {p}_{1} log {p}_{1} \qquad ( 1 )$$

Wherein p₀: The probability of a bit being 0 in the input biased bitstream.
p₁: The probability of a bit being 1 in the input biased bitstream.

As an example, the value of Y may be 160, or 256 based on whether the SHA160 bit or the SHA256 is applicable. The SHA160 generates the 160-bit hash output. However, in the case of SHA256, the 256-bit hash output is generated. For yet another example, the value of S_{avg} is generally always between zero to 1. Therefore, the value of X is always greater than the value of Y. In this scenario, if the value of S_{avg} is 0.16 and the number of hash bits is required as 160 bits, then a bitstream of ┌160/0.16┐=1000 bit is extracted from the input biased bitstream for receiving 160-bit unbiased hash bitstream.

The Lhlrand method utilizes the SHA and a Leftover Hash Lemma (LHL) based randomness extraction process for generating the random unbiased bitstream from the biased bitstream. The Lhlrand method includes the following operations:
Operation 1: Determine a value of Xᵢ, wherein i is the number of output hash bits;
Operation 2: Extract a bitstream of Xᵢ bits from the input biased bitstream; and
Operation 3: Calculate the SHA hash of the Xᵢ bits bitstream to generate i bit unbiased hash bitstream, which is random in nature.

For example, the calculation of determining the value of Xi is given in equations (2) and (3), wherein i relates to 160 bits and 256 bits, respectively.

$${x}_{160} = ⌈ \frac{v - 2 log ε}{m} ] = ⌈ \frac{160 + 2 \times 64}{- log {p}_{max}} ] \qquad ( 2 )$$

$${x}_{256} = ⌈ \frac{v - 2 log ε}{m} ⌉ = ⌈ \frac{256 + 2 \times 64}{- log {p}_{max}} ⌉ \qquad ( 3 )$$

The SHA hash function extracts ν bits from a distribution with minimum entropy per bit m. In this scenario, ε is to be close to uniform (that is, an n bit string of the Lhlrand method contains at least (1−ε)n bits of entropy), wherein the value of ε to be 0≤ε≤2⁻⁶⁴ that is recommended for Random Bit Generator construction. Further, the calculation of pₘₐₓ is defined by equation (4).

$${p}_{max} = max ( {p}_{0} , {p}_{1} ) \qquad ( 4 )$$

wherein p₀: The probability of a bit being 0 in the badrand bitstream.
p₁: The probability of a bit being 1 in the badrand bitstream.

The Minrand method utilizes the SHA and a Minimum Entropy based randomness extraction process. The Minimum Entropy based randomness extraction process is utilized for determining an entropy per bit of the bitstream. The entropy relates to the information available in each bit. The Avgrand method performs the following operations:
Operation 1: Determine minimum entropy per bit Sₘᵢₙ, for each bit of the input biased bitstream;
Operation 2: Determine X by taking a ceiling value of Y divided by Sₘᵢₙ, wherein Y is the number of output bits required from the SHA process, X is a variable integer; and
Operation 3: Extract a bitstream of X bits from the input biased bitstream; and
Operation 4: Calculate the SHA hash of the X bits bitstream to generate Y bit unbiased hash bitstream, which is random in nature.

For example, the calculation of determining the entropy per bit Sₘᵢₙ is given in equations (5) and (6).

$${s}_{min} = log {p}_{max} \qquad ( 5 )$$

$${p}_{max} = max ( {p}_{0} , {p}_{1} ) \qquad ( 6 )$$

Wherein p₀: The probability of a bit being 0 in the badrand bitstream.
p₁: The probability of a bit being 1 in the badrand bitstream.

The Sinrand method utilizes a Chaotic Sine based randomness extraction process. The chaotic or random behavior of

$$sin \frac{1}{x}$$

for x very close to 0 is well established. Therefore, it follows that near chaotic or random behavior is expected for sin y∀y∈Z, for large y, when y is restricted to being an integer. Therefore, the chaotic behavior is utilized as a randomness extractor through the following operations:
Operation 1: Extract the next x bits of the input biased bitstream, wherein x can be any integer value whose value is the power of two;
Operation 2: Convert the extracted x bits of input into decimal number n;
Operation 3: Calculate z=sin n, considering n to be in radians;
Operation 4: If z<0, output 0; or
Operation 5: Else If z>0, output 1.

As a non-limiting example, the value of x is 64 bits.

In general, the behavior of

$$sin \frac{1}{x}$$

becomes increasingly chaotic as x→0. Therefore, the behavior of sin y∀y∈Z would become increasingly random for larger y. Thus, the Sinrand method calculates the sine of a 64-bit number to extract one bit only, which may be statistically uniform.

Among all of the plurality of randomness extraction methods, the Sinrand method is the least austere in its consumption of the biased sequence as compared to the other methods. In the Sinrand method, for example, 64 bits of input biased bitstream produce one bit of one output bit. On contrary, the amount of time required for the Sinrand method is more than other methods.

In an embodiment, the key generator module 207 receives the unbiased bitstream from the randomness extractor module 205. Thereby, the key generator module 207 generates a random cryptographic key based on the generated unbiased bitstream. Upon generating the random cryptographic key, the key generator module 207 transmits the key to the OS 211. Further, the OS 211 transmits the random cryptographic key to the encryption module 201 for encrypting the plaintext into the ciphertext. Subsequently, the encryption module 201 transmits the ciphertext to the application 209 for transmitting to the receiver device via the communication interface 217.

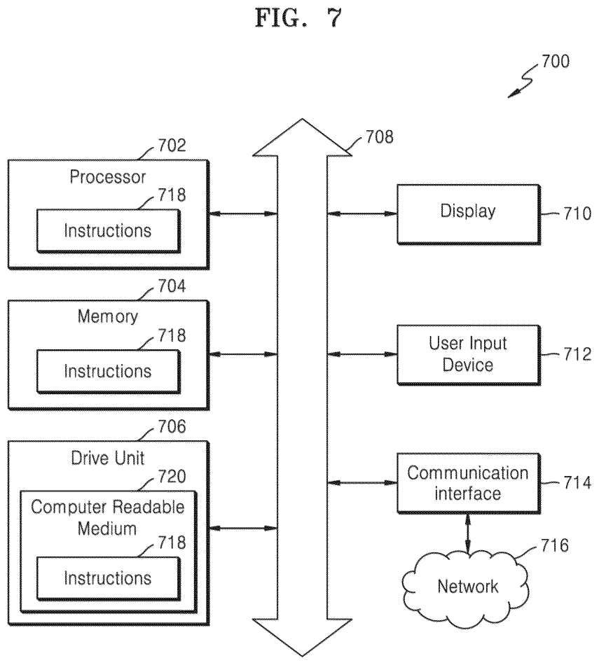

For the sake of brevity and to increase the succinctness of the specification the communication interface 217, and the output device 215 are described in later sections of the specification in FIG. 7, wherein the communication interface 217 relates to communication interface 714, and the output device 215 relates to display 710.

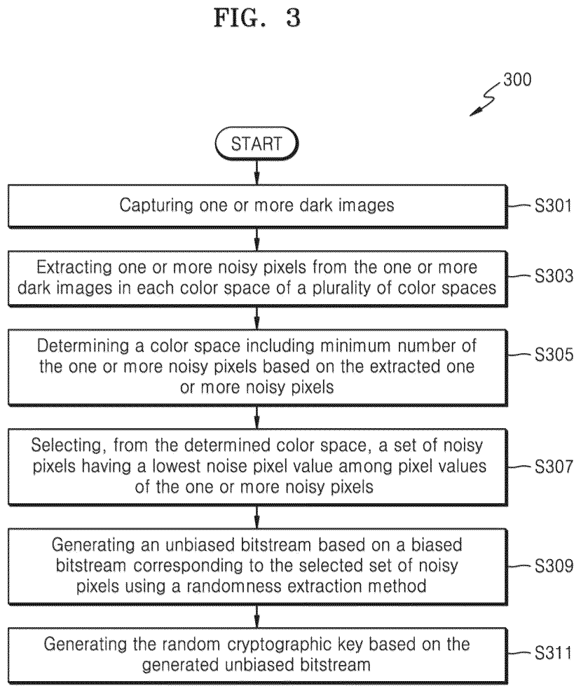

FIG. 3 illustrates a flowchart of a method of secure communication, in accordance with an embodiment of the present disclosure. FIG. 3 illustrates a secure communication method 300 for generating a random cryptographic key using a quantum method. The quantum method utilizes an inbuild hardware component of a device. For example, the inbuild hardware component is an image sensor in the mobile device.

At operation S301, the method 300 comprises capturing one or more dark images. An image sensor 105 of the device 101, captures one or more dark images, wherein each of the one or more dark images includes a dark noise region in its entirety. In an embodiment, the one or more dark images are captured in such a way that only dark noise is present in each of the one or more dark images. Further, the one or more dark images are captured excluding any use of a light source. Further, the image sensor 105 is entirely covered manually or by a robotic hardware in order to block any ambient light source from entering the image sensor 105.

At operation S303, the method 300 further comprises extracting one or more noisy pixels from the one or more dark images in each color space of a plurality of color spaces. Although, in operation S301, the image sensor captures the one or more dark images, the dark noise region of the one or more dark images includes the one or more noisy pixels and a plurality of noiseless pixels. The one or more noisy pixels may be generated by the quantum method or a non-quantum method while capturing the one or more dark images. In a non-limiting example, the plurality of color spaces may include RGB color spaces. In operation S303, the method determines the one or more noisy pixels in each of the RGB color spaces, that is, in R (red) or G (green), or B (blue) color space. In an non-limiting example, the method determines 50 bits of noisy pixels in the G color space, 60 bits of noisy pixels in the R color space, and 70 bits of noisy pixels in the B color space.

At operation S305, the method 300 further includes determining a color space including minimum number of the one or more noisy pixels based on the extracted one or more noisy pixels in operation S303. Therefore, the method, at operation S305, determines the color space in which the least number of one or more noisy pixels are present as large number of noisy pixels may correspond to contamination of the noise generated by the non-quantum effect. In a non-liming example, the method determines the G color space having 50 bits of noisy pixels, as other color spaces include more noisy pixels (i.e., 60 bits of noisy pixels in the R color space, and 70 bits of noisy pixels in the B color space).

At operation S307, the method 300 further includes selecting, from the determined color space, a set of noisy pixels having a lowest pixel value among pixel values of the one or more noisy pixels. The method includes selecting the set of noisy pixels by the processor 107 utilizing the quantum noise separator module 203. The set of noisy pixels may include noisy pixels of varying pixel value, wherein the pixel value corresponds to a positive integer value. In operation S307, the method only selects the noisy pixels having the lowest pixel value. In this operation, the lowest pixel value is selected to eliminate the noisy pixels of higher pixel value, because the non-quantum effect may contaminate the noise into the noisy pixels of the higher pixel value. Therefore, the noisy pixel of the lowest pixel value is selected to determine whether they are generated due to the quantum effect. In a non-limiting example, the selected G color space having 50 bits of noisy pixels may have pixel values of 1, 20, 35, 30, etc. The method only selects the set of noisy pixels having a pixel value of 1. In general, the lowest pixel value of the noisy pixels corresponds to 1.

At operation S309, the method 300 further includes generating an unbiased bitstream based on a biased bitstream corresponding to the selected set of noisy pixels using a randomness extraction method. The unbiased bitstream is generated by the processor 107 utilizing the randomness extractor module 205 by a randomness extraction method among a plurality of randomness extraction methods. The biased bitstream includes maximum bits of zero-value pixels (i.e., the noiseless pixels) and a few of the selected sets of noisy pixels having the lowest pixel value. However, the unbiased bitstream corresponds to the total number of one or more noisy pixels is nearly similar to the total number of the plurality of noiseless pixels. Further, the plurality of randomness extraction methods comprises at least one of a Vonrand, an Avgrand method, a Lhlrand method, a Minrand method, or a Sinrand method. In a non-limiting example, the processor generates 256 bits unbiased bitstream from the input biased bitstream of 1000 bits, in which, the biased bitstream includes 99.7% of zero value pixels and only 0.3% of the pixels with pixel value 1. Further, in the unbiased bitstream, the number of the zero value pixels is nearly similar to the pixels with the pixel value one.

At operation S311, the method 300 includes generating a random cryptographic key based on the generated unbiased bitstream. As the unbiased bitstream is generated by extracting the quantum noise, therefore, the generated bitstream is unique and of a truly random nature that cannot be predicted in advance by any means. Further, the random cryptographic key is also unique and of a truly random nature as the unbiased bitstream is truly random based unique bitstream. Further, an encryption operation or a decryption operation may be performed using the generated random cryptographic key. The encrypted text is highly secure due to the truly random cryptographic key.

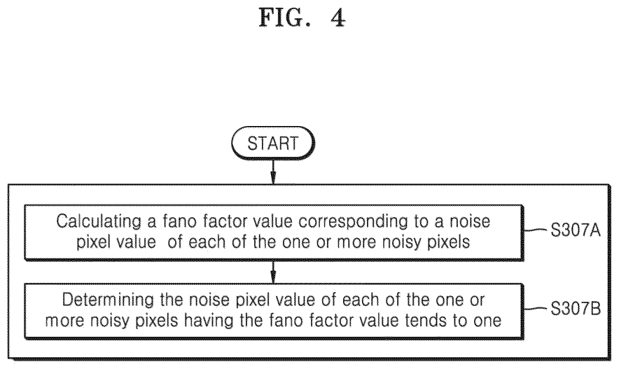

FIG. 4 illustrates a flowchart of subsequent operations of operation S307 as disclosed in FIG. 3, in accordance with an embodiment of the present disclosure.

FIG. 4 discloses detailed operations for selecting the set of noisy pixels having the lowest pixel value among pixel values of the one or more noisy pixels as disclosed in operation S307. For selecting the set of noisy pixels with the lowest pixel value, in operation S307A, the method further includes calculating a Fano factor value corresponding to a pixel value of each of the one or more noisy pixels. The Fano factor value is a ratio of variance of the pixel values of the one or more noisy pixels and the plurality of noiseless pixels to a mean of the pixel values. Therefore, the method calculates the mean of the pixel values of all noisy and noiseless pixels, and the variance of the pixel values of all noisy and noiseless pixels. The method further determines the ratio of the variance and the mean, wherein the determined ratio is the Fano factor.

The method, in operation S307B, the method includes determining the pixel value of each of the one or more noisy pixels having the Fano factor value tends to one. The Fano factor value tends to one indicates that the pixel value of the one or more noisy pixels is generated in the one or more dark images as a result of the quantum effect.

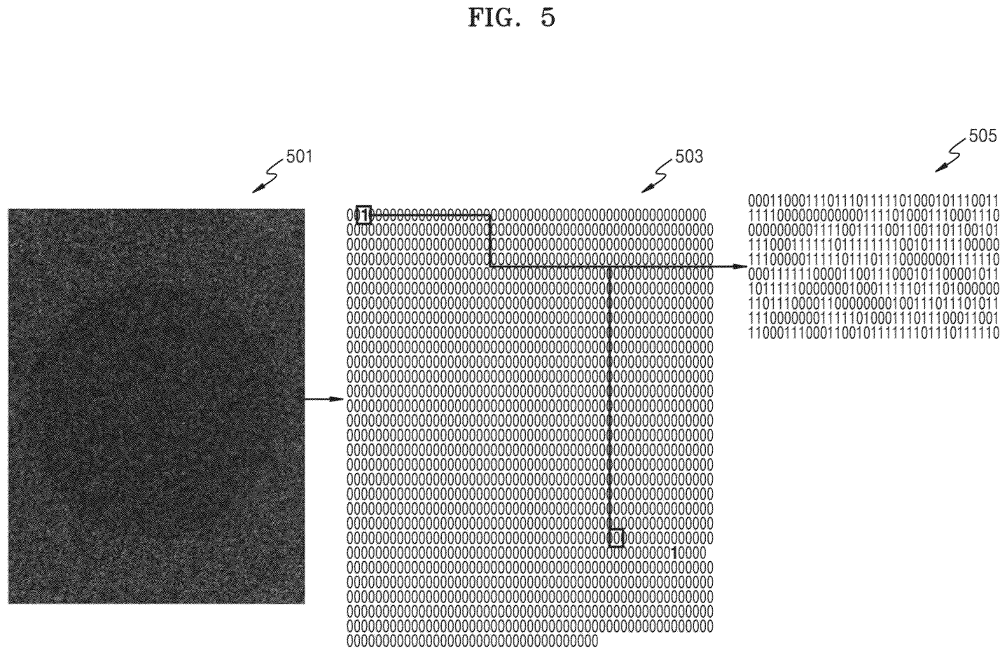

FIG. 5 illustrates an example use case of determining an unbiased bit stream from a dark noise input, in accordance with an embodiment of the present disclosure. FIG. 5 illustrates the dark noise input 501, which is captured by the image sensor 105. The dark noise input 501 is a dark image without any light source and the aperture of the image sensor 105 is completely obstructed such that ambient light cannot enter into the image sensor in any condition. For a non-limiting example, the dark noise input is captured by the S21 Samsung mobile phone.

The dark noise input 501 may include a plurality of noiseless pixels and one or more noisy pixels in the biased bitstream 503, in which most of the bitstream relates to the noiseless pixels and the least number of the bitstream relates to the noisy pixels. In the biased bitstream 503, the pixel value of the noiseless pixels is zero and the pixel value of the plurality of noisy pixels is 1. In an embodiment, the pixel value of the noisy pixels may be any positive natural number. For a non-limiting example, the dark noise input captured by the S21 Samsung mobile phone includes 99.81% zeros (noiseless pixels) and 0.18% ones (noisy pixels). Further, the Fano factor of the noisy pixels is 0.99816. The Fano factor of the noisy pixel tends to one indicates that the noisy pixel is generated by the quantum effect.

The unbiased bitstream 505 is further generated from the biased bitstream 503 utilizing the randomness extraction method among the plurality of randomness extraction methods. In the unbiased bitstream 505, the total number of noisy pixels is almost similar to the total number of noiseless pixels. In addition, the random cryptographic key is generated from the unbiased bitstream.

In an example embodiment, the random cryptographic key generated by the present disclosure passes all 15 tests of a standard test suite, that is, the NIST 800-22 test suite. The test suite result is disclosed in Table 1 (as shown below). The result discloses that the Vonrand method passes 12 tests (failed data set is shown in bold font) of the 15 datasets. Further, the Sinrand method passes 15 tests out of 15 datasets. However, the Sinrand method calculates the sine of a 64-bit number to extract one bit only. Therefore, the Sinrand method has high time complexity. On contrary, the Vonrand method has low time complexity. Thus, the selection of the randomness extraction method is based on user requirements. In a non-limiting example, if the user requires a highly secure or complex random cryptographic key, in which time complexity may be higher. In this scenario, the Sinrand method is selected for generating the random cryptographic key. In an non-limiting example, if the user requires a medium secure or complex random cryptographic key, in which the time complexity should be lower. In this scenario, the Vonrand method is selected for generating the random cryptographic key.

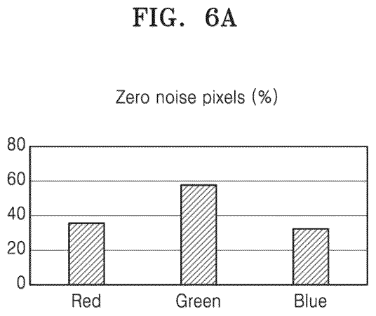

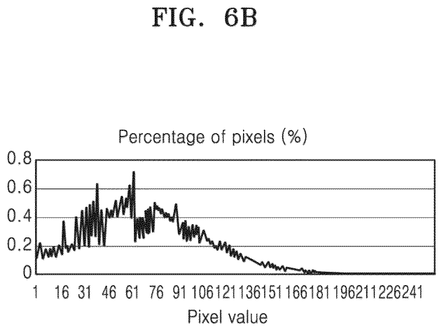

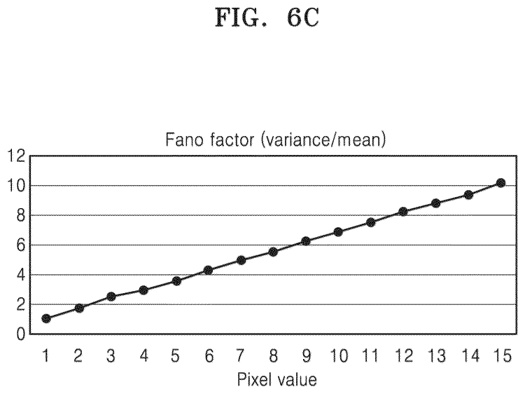

FIG. 6A illustrates a column chart disclosing a percentage of zero-value pixels in each color space, in accordance with an example embodiment of the present disclosure. FIG. 6A illustrates pixel percentage in three color spaces, such as green, red, and blue. As can be seen in FIG. 6A, the green color space includes almost 58% of zero-pixel values (i.e., the noiseless pixels). Further, the red color space and the blue color space include almost 35% and 31% of zero-pixel values, respectively. Therefore, the green color space contains the least number of noisy pixels. Therefore, the green color space is determined by quantum noise separator module 203 for determining the biased bitstream.

TABLE 1

| | | | | | | avgrand | minrand | | |
|---|---|---|---|---|---|---|---|---|---|
| | badrand | vonrand | avgrand | mintand | lhlrand | 2 | 2 | lhrand | Sinrand |
| Time for | 2.628 | 27.122 | 9.711 | 26.540 | 46.365 | 10.044 | 25.475 | 37.522 | 292.457 |
| 100 Mbit | | | | | | | | | |
| (Seconds) | | | | | | | | | |
| Num. of bits | 1 | −4 | 1.85 | 5.20 | 9.35 | 1.84 | 5.22 | 7.81 | 64 |
| of bedrand | | | | | | | | | |
| for one bit | | | | | | | | | |

Tests from the NIST Statistical Test Suite

| | | | | | | | | | |
|---|---|---|---|---|---|---|---|---|---|
| Frequency | 0/100 | 99/100 | 100/100 | 100/100 | 99/100 | 99/100 | 100/100 | 98/100 | 98/100 |
| Block | 0/100 | 99/100 | 100/100 | 100/100 | 99/100 | 100/100 | 100/100 | 99/100 | 99/100 |
| Frequency | | | | | | | | | |
| Cumulative | 0/100 | 100/100 | 99/100 | 100/100 | 99/100 | 98/100 | 100/100 | 99/100 | 97/100 |
| Sums | | | | | | | | | |
| Runs | 0/100 | 88/100 | 100/100 | 98/100 | 97/100 | 92/100 | 98/100 | 100/100 | 99/100 |
| Longest Run | 0/100 | 99/100 | 98/100 | 99/100 | 99/100 | 100/100 | 100/100 | 98/100 | 99/100 |
| Rank | 0/100 | 100/100 | 100/100 | 97/100 | 100/100 | 99/100 | 98/100 | 98/100 | 100/100 |
| Fast Fourier | 0/100 | 100/100 | 99/100 | 100/100 | 98/100 | 97/100 | 99/100 | 99/100 | 99/100 |
| Transform | | | | | | | | | |
| Non- | 0/100 | 77/100 | 97/100 | 95/100 | 94/100 | 95/100 | 95/100 | 96/100 | 96/100 |
| Overlapping | | | | | | | | | |
| Template | | | | | | | | | |
| Overlapping | 0/100 | 97/100 | 99/100 | 99/100 | 100/100 | 98/100 | 99/100 | 97/100 | 99/100 |
| Template | | | | | | | | | |
| Universal | 0/100 | 99/100 | 97/100 | 99/100 | 99/100 | 98/100 | 96/100 | 98/100 | 100/100 |
| Approximate | 0/100 | 71/100 | 100/100 | 98/100 | 99/100 | 100/100 | 100/100 | 99/100 | 99/100 |
| Entropy | | | | | | | | | |
| Random | NA | 52/55 | 59/60 | 61/62 | 70/71 | 55/56 | 52/56 | 50/52 | 49/50 |
| Excursions | | | | | | | | | |
| Random | NA | 52/55 | 59/60 | 62/62 | 68/71 | 54/56 | 53/56 | 50/52 | 49/50 |
| Excursions | | | | | | | | | |
| Variant | | | | | | | | | |
| Serial | 0/100 | 97/100 | 99/100 | 100*/00 | 98/100 | 99/100 | 97/100 | 99/100 | 99/100 |
| Linear | 99/100 | 98/100 | 99/100 | 97/100 | 98/100 | 100/100 | 99/100 | 98/100 | 100/100 |
| Complexity | | | | | | | | | |

FIG. 6B illustrates an example representation depicting a percentage of noisy pixel values in one or more dark images, in accordance with an example embodiment of the present disclosure. FIG. 6B illustrates the pixel value of the noisy pixels on the X-axis and the percentage of the pixel value on the Y-axis. As can be seen in FIG. 6B of the drawings, the number of pixels with the pixel value 46-90 is much higher than the number of pixels with the pixel value 1.

FIG. 6C illustrates a Fano factor value with respect to a pixel value, in accordance with an example embodiment of the present disclosure. FIG. 6C illustrates the pixel value of the noisy pixels on the X-axis and the Fano factor value with respect to the pixel value on the Y-axis. FIG. 6C illustrates that the Fano factor value increases in proportion to the pixel value. Thus, the Fano factor close to one is generally determined from the pixel with pixel value 1.

Referring now to the technical abilities and effectiveness of the method and system disclosed herein, provides the following technical advantages over the conventional and existing state of the art such as playing an important role in eliminating the need of costly external hardware installation for random number generation by determining a truly random number that is generated by the quantum effect utilizing the hardware available in the device. The technical advantages also include providing aid in highly secure communication, such as defense communication, corporate bonds transaction, communication between top levels government officials, etc., by encrypting the plain text with the generated random cryptographic key. Further, the technical advantages also include providing sufficient randomness in the VoLTE encryption method to overcome the ReVoLTE attack. In addition, the method and system disclosed herein can also be applied to the IoT ecosystem that may use the generated random cryptographic key for preventing the remote-control attacks.

Referring now to FIG. 7 of the Drawings, FIG. 7 illustrates an example implementation of a typical hardware configuration of the system 200 in the form of a computer system 700, in accordance with an embodiment of the present disclosure. The computer system 700 can include a set of instructions that can be executed to cause the computer system 700 to perform any one or more of the methods disclosed. The computer system 700 may operate as a standalone device or may be connected, e.g., using a network, to other computer systems or peripheral devices.

In a networked deployment, the computer system 700 may operate in the capacity of a server or as a client-user computer in a server-client user network environment, or as a peer computer system in a peer-to-peer (or distributed) network environment. The computer system 700 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 700 is illustrated, the term “system” shall also be taken to include any collection of systems or sub-systems that individually or jointly execute a set, or multiple sets, of instructions to perform one or more computer functions.

The computer system 700 may include a processor 702 e.g., a central processing unit (CPU), a graphics processing unit (GPU), or both. The processor 702 may be a component in a variety of systems. As an example embodiment, the processor 702 may be part of a standard personal computer or a workstation. The processor 702 may be one or more general processors, digital signal processors, application-specific integrated circuits, field-programmable gate arrays, servers, networks, digital circuits, analog circuits, combinations thereof, or other now-known or later developed devices for analyzing and processing data. The processor 702 may implement a software program, such as code generated manually (i.e., programmed).

The computer system 700 may include a memory 704, such as a memory 704 that can communicate via a bus 708. The memory 704 may include but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 704 includes a cache or random-access memory for the processor 702. In alternative examples, the memory 704 is separate from the processor 702, such as a cache memory of a processor, the system memory, or other memory. The memory 704 may be an external storage device or database for storing data. The memory 704 is operable to store instructions executable by the processor 702. The functions, acts, or tasks illustrated in the figures or described may be performed by the programmed processor 702 for executing the instructions stored in the memory 704. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

As shown, the computer system 700 may or may not further include a display unit (display 710), such as a liquid crystal display (LCD), an organic light-emitting diode (OLED), a flat panel display, a solid-state display, a projector, a printer or other now known or later developed display device for outputting determined information. The display 710 may act as an interface for the user to see the functioning of the processor 702, or specifically as an interface with the software stored in the memory 704 or the drive unit 706.

Additionally, the computer system 700 may include an input device 712 configured to allow a user to interact with any of the components of system 700. The computer system 700 may also include a disk or optical drive unit 706. The disk drive unit 706 may include a computer-readable medium 720 in which one or more sets of instructions 718, e.g., software, can be embedded. Further, instruction 718 may embody one or more of the methods or logic as described. In a particular example, the instruction 718 may reside completely, or at least partially, within the memory 704 or the processor 702 during execution by the computer system 700.

The present disclosure contemplates a computer-readable medium that includes instructions 718 or receives and executes instructions 718 responsive to a propagated signal so that a device connected to a network 716 can communicate voice, video, audio, and images or any other data over the network 716. Further, instructions 718 may be transmitted or received over the network 716 via a communication port or interface 714 or using a bus 708. The communication port or interface 714 may be a part of the processor 702 or maybe a separate component. The communication port 714 may be created in software or maybe a physical connection in hardware. The communication port 714 may be configured to connect with a network 716, external media, the display 710, or any other components in system 700, or combinations thereof. The connection with the network 716 may be a physical connection, such as a wired Ethernet connection, or may be established wirelessly as discussed later. Likewise, the additional connections with other components of the system 700 may be physical or may be established wirelessly. The network 716 may alternatively be directly connected to bus 708.

The network 716 may include wired networks, wireless networks, Ethernet AVB networks, or combinations thereof. The wireless network may be a cellular telephone network, an 802.11, 802.16, 802.20, 802.1Q, or WiMax network. Further, the network 716 may be a public network, such as the Internet, a private network, such as an intranet, or combinations thereof, and may utilize a variety of networking protocols now available or later developed including, but not limited to TCP/IP-based networking protocols. The system is not limited to operation with any particular standards and protocols. As an example embodiment, standards for Internet and other packet-switched network transmissions (e.g., TCP/IP, UDP/IP, HTML, and HTTP) may be used.

While specific language has been used to describe the disclosure, any limitations arising on account of the same are not intended. As would be apparent to a person in the art, various working modifications may be made to the method in order to implement the disclosure as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

In an embodiment of the disclosure, the present subject matter refers to a method for secure communication. The method further includes capturing one or more dark images including a dark noise region. Further, the method includes extracting one or more noisy pixels from the one or more dark images in each color space of a plurality of color spaces. Upon extracting the one or more noisy pixels, the method includes determining a color space including minimum number of the one or more noisy pixels based on the extracted one or more noisy pixels. Subsequently, the method includes selecting from the determined color space, a set of noisy pixels having a lowest pixel value among pixel values of the one or more noisy pixels. Further, the method includes generating an unbiased bitstream based on a biased bitstream corresponding to the selected set of noisy pixels using a randomness extraction method among a plurality of randomness extraction methods. Subsequently, the method includes generating the random cryptographic key based on the generated unbiased bitstream.

In an embodiment of the disclosure, the dark noise region includes the one or more pixels and a plurality of noiseless pixels, and the one or more noisy pixels are generated as a result of one of a quantum effect or a non-quantum effect while capturing the one or more dark images.

In an embodiment of the disclosure, the method further comprises calculating a Fano factor value corresponding to a pixel value of each of the one or more noisy pixels, wherein the Fano factor value is a ratio of the variance of the pixel values of the one or more noisy pixels and the plurality of noiseless pixels to a mean of the pixel values. The method comprises determining the pixel value of each of the one or more noisy pixels having the Fano factor value tends to one, wherein the Fano factor value tends to one indicates that the pixel value of the one or more noisy pixels is generated as a result of the quantum effect.

In an embodiment of the disclosure, the pixel value of each of the plurality of noiseless pixels corresponds to zero, and the pixel value of the one or more noisy pixels corresponds to a positive integer value.

In an embodiment of the disclosure, the biased bitstream corresponds to a bitstream in which a fraction value of a total number of the one or more noisy pixels with respect to a total number of the plurality of noiseless pixels tends toward zero, and the unbiased bitstream corresponds to a bitstream in which the fraction value of the total number of the one or more noisy pixels with respect to the total number of the plurality of noiseless pixels tends towards one.

In an embodiment of the disclosure, the plurality of color spaces includes a red color space, a green color space, and a blue color space.

In an embodiment of the disclosure, the plurality of randomness extraction methods comprise at least one of an Avgrand method including a SHA (Secure Hash Algorithm) and a Shannon Entropy based randomness extraction process, a Lhlrand method including the SHA and a Leftover Hash Lemma based randomness extraction process, a Minrand method including the SHA and a Minimum Entropy based randomness extraction process, or a Sinrand method including a Chaotic Sine based randomness extraction process.

In an embodiment of the disclosure, a selection of one of the plurality of randomness extraction methods is based on a user requirement for the generation of the random cryptographic key, and the user requirement is associated with at least one of a time taken by the processor to generate the cryptographic key or a complexity level of the generated cryptographic key.

In an embodiment of the disclosure, the one or more dark images are capture in such a way that only dark noise is present in each of the one or more dark images, and a use of light source is excluded.

In an embodiment of the disclosure, the method further comprises performing an encryption operation or a decryption operation using the generated random cryptographic key.

In an embodiment of the disclosure, a system for secure communication is disclosed. The system includes an image sensor, at least one processor, and one or more memories. The at least on processor is communicatively coupled with the image sensors and one or more memories. The image sensor is configured to capture one or more dark images each including a dark noise region. Further, the at least one processor is configured to extract one or more noisy pixels from the one or more dark images in each color space of a plurality of color spaces. The at least one processor is also configured to determine a color space that corresponds to least number of the one or more noisy pixels based on the extracted one or more noisy pixels. Furthermore, the at least one processor is configured to select a set of noisy pixels having a lowest pixel value among noise pixel values of the one or more noisy pixels from the determined color space. The at least one processor is configured to subsequently generate an unbiased bitstream based on a biased bitstream corresponding to the selected set of noisy pixels using a randomness extraction method among a plurality of randomness extraction methods. Also, the processor is configured to generate the random cryptographic key based on the generated unbiased bitstream.

In an embodiment of the disclosure, a machine-readable medium containing instructions that, when executed, cause at least one processor of a device to perform operation corresponding to the described method in the disclosure.

Embodiments of the method and system described herein improve the functioning of a computer by enabling generation of a random cryptographic key by capturing at least one dark image. This can avoid the need to use specialized and/or sophisticated hardware to generate a random cryptographic key. This problem of generating a random cryptographic key without specialized and/or sophisticated hardware is present in the realm of computation and networks. Thus, embodiments herein are rooted in computer technology to overcome a problem arising in the realm of computer networks.

What is claimed is:

1. A method for secure communication, the method comprising:
capturing at least one dark image comprising a dark noise region;
extracting at least one noisy pixel from the at least one dark image in a plurality of color spaces;
determining a color space, among the plurality of color spaces, comprising a minimum number of the at least one noisy pixel, based on the at least one noisy pixel;
selecting, from the color space, a set of the at least one noisy pixel having a lowest pixel value;
generating an unbiased bitstream based on a biased bitstream corresponding to the set of the at least one noisy pixel using a randomness extraction method; and
generating a random cryptographic key based on the unbiased bitstream.

2. The method of claim 1, wherein the dark noise region comprises the at least one noisy pixel and a plurality of noiseless pixels, and
wherein the at least one noisy pixel is generated as a result of one of a quantum effect or a non-quantum effect while capturing the at least one dark image.

3. The method of claim 2, wherein the selecting the set of the at least one noisy pixel comprises:
determining at least one Fano factor value corresponding to at least one pixel value of the at least one noisy pixel, wherein the at least one Fano factor value is a ratio of variance of pixel values of the at least one noisy pixel and the plurality of noiseless pixels to a mean of the pixel values of the at least one noisy pixel and the plurality of noiseless pixels; and
determining the at least one pixel value of the at least one noisy pixel having the at least one Fano factor value tending to one, wherein the at least one Fano factor value tending to one indicates that the at least one pixel value of the at least one noisy pixel is generated as the result of the quantum effect.

4. The method of claim 3, wherein the pixel values of the plurality of noiseless pixels corresponds to zero, and
wherein the at least one pixel value of the at least one noisy pixel corresponds to a positive integer value.

5. The method of claim 2, wherein the biased bitstream corresponds to a bitstream in which a fraction value of a total number of the at least one noisy pixel with respect to a total number of the plurality of noiseless pixels tends to zero, and
wherein the unbiased bitstream corresponds to a bitstream in which the fraction value of the total number of the at least one noisy pixel with respect to the total number of the plurality of noiseless pixels tends to one.

6. The method of claim 1, wherein the randomness extraction method is at least one of: an Avgrand method comprising a SHA (Secure Hash Algorithm) and a Shannon Entropy based randomness extraction process, a Lhlrand method comprising the SHA and a Leftover Hash Lemma based randomness extraction process, a Minrand method comprising the SHA and a Minimum Entropy based randomness extraction process, or a Sinrand method comprising a Chaotic Sine based randomness extraction process.

7. The method of claim 6, wherein the randomness extraction method is selected based on a user requirement for the generating the random cryptographic key, and
wherein the user requirement is associated with at least one of: a time taken by at least one processor to generate the random cryptographic key, or a complexity level of the random cryptographic key.

8. The method of claim 1, wherein the at least one dark image is captured so that only dark noise is present in the at least one dark image, and use of light source is excluded.

9. The method of claim 1, further comprising:
performing an encryption operation or a decryption operation using the random cryptographic key.

10. A device for secure communication, the device comprising:
an image sensor configured to capture at least one dark image comprising a dark noise region;
memory storing at least one instruction; and
at least one processor operatively coupled with the image sensor and the memory,
wherein the at least one instruction, when executed by the at least one processor individually or collectively, causes the device to:
extract at least one noisy pixel from the at least one dark image in a plurality of color spaces;
determine a color space comprising a minimum number of the at least one noisy pixel, based on the at least one noisy pixel;
select, from the color space, a set of the at least one noisy pixel having a lowest pixel value;
generate, using a randomness extraction method, an unbiased bitstream based on a biased bitstream corresponding to the set of the at least one noisy pixel; and
generate a random cryptographic key based on the unbiased bitstream.

11. The device of claim 10, wherein the dark noise region comprises the at least one noisy pixel and a plurality of noiseless pixels, and
wherein the at least one noisy pixel is generated as a result of one of a quantum effect or a non-quantum effect while capturing the at least one dark image.

12. The device of claim 11, wherein, for the select the set of the at least one noisy pixel, the at least one instruction, individually or collectively, causes the device to select the set of the at least one noisy pixel by:
determining at least one Fano factor value corresponding to at least one pixel value of the at least one noisy pixel, wherein the at least one Fano factor value is a ratio of variance of pixel values of the at least one noisy pixel and the plurality of noiseless pixels to a mean of the pixel values of the at least one noisy pixel and the plurality of noiseless pixels; and
determining the at least one pixel value of the at least one noisy pixel having the at least one Fano factor value tending to one, wherein the at least one Fano factor value tending to one indicates that the at least one pixel value of the at least one noisy pixel is generated as the result of the quantum effect.

13. The device of claim 12, wherein the pixel values of the plurality of noiseless pixels corresponds to zero, and
wherein the at least one pixel value of the at least one noisy pixel corresponds to a positive integer value.

14. The device of claim 11, wherein the biased bitstream corresponds to a bitstream in which a fraction value of a total number of the at least one noisy pixel with respect to a total number of the plurality of noiseless pixels tends to zero, and
wherein the unbiased bitstream corresponds to a bitstream in which the fraction value of the total number of the at least one noisy pixel with respect to the total number of the plurality of noiseless pixels tends to one.

15. The device of claim 10, wherein the randomness extraction method is at least one of: an Avgrand method comprising a SHA (Secure Hash Algorithm) and a Shannon Entropy based randomness extraction process, a Lhlrand method comprising the SHA and a Leftover Hash Lemma based randomness extraction process, a Minrand method comprising the SHA and a Minimum Entropy based randomness extraction process, or a Sinrand method comprising a Chaotic Sine based randomness extraction process.

16. The device of claim 15, wherein the randomness extraction method is selected based on a user requirement for the generating the random cryptographic key, and
wherein the user requirement is associated with at least one of: a time taken by at least one processor to generate the random cryptographic key, or a complexity level of the random cryptographic key.

17. The device of claim 10, wherein the at least one dark image is captured so that only dark noise is present in the at least one dark image, and use of light source is excluded.

18. The device of claim 10, wherein the at least one instruction, when executed by the at least one processor individually or collectively, causes the device to:
perform an encryption operation or a decryption operation using the random cryptographic key.

19. A non-transitory machine-readable medium containing instructions that, when executed, cause at least one processor of a device to perform a method for secure communication, the method comprising:
capturing at least one dark image comprising a dark noise region;
extracting at least one noisy pixel from the at least one dark image in a plurality of color spaces;
determining a color space, among the plurality of color spaces, comprising a minimum number of the at least one noisy pixel, based on the at least one noisy pixel;
selecting, from the color space, a set of the at least one noisy pixel having a lowest pixel value;
generating an unbiased bitstream based on a biased bitstream corresponding to the set of the at least one noisy pixel using a randomness extraction method; and
generating a random cryptographic key based on the unbiased bitstream.
